(19) United States
(12) Patent Application Publication
(10) Pub. No.: US 2026/0266124 A1
(43) Pub. Date: Sep. 10, 2026

(54) Snap-Together Fire Resistant Fenestration Frame Apparatus

(71) Applicants: William F O'KEEFFE, Brisbane, CA (US); O'Keeffe's, Inc., Brisbane, CA (US)

(72) Inventor: William F O'Keeffe, Brisbane, CA (US)

(73) Assignee: O'Keeffe's Inc., Brisbane, CA (US)

(21) Appl. No.: 19/162,939

(22) PCT Filed: Mar. 8, 2024
(86) PCT No.: PCT/US2024/019156

§ 371 Date: Sep. 7, 2025

Related U.S. Application Data
(60) Provisional application No. 63/450,775, filed on Mar. 8, 2023.

(51) Int. Cl. E06B 3/54; E06B 3/26; E06B 3/968

(52) U.S. Cl. CPC E06B 3/549; E06B 3/26; E06B 3/968

(57) ABSTRACT

A device, system, and method for providing an easily assembled window framing device that can be fire rated and that can hold window panels of various designs and construction for use in a building. The device utilizes a plurality of connecting members that can be constructed of a light-weight material such as aluminum and snap connectors that allow an inner frame to be installed connected to a building structure with the outer frame being “snapped” into place for holding various types of window panels.

### CROSS-REFERENCES TO RELATED APPLICATIONS

This application is a national stage application for PCT application serial number PCT/US2024/019156 filed on Mar. 8, 2024, which claims the benefit of U.S. provisional patent application Ser. No. 63/450,775, filed on Mar. 8, 2023, both incorporated herein by reference.

### BACKGROUND

Buildings of modern construction are often required to include doors and windows that are deemed to be resistant to fire over a specific period of time. The combination of fire rated glass and framing must be matched in order for the full assembly of glazing and framing to meet the requirements of certain codes.

In the past, the most common frame employed in fire resistant assemblies has been the hollow metal frame. Further development in this field have included the use of fire resistant framing with the ability to block the spread of radiant heat.

U.S. Pat. No. 9,234,345, incorporated by reference, discloses a snap together frame that improved upon the state of the art. Nevertheless, many improvements and enhancements to that frame were found to be desirable, which are disclosed by this application.

### SUMMARY

Provided are a plurality of example embodiments, including, but not limited to, a snap together frame comprised primarily of aluminum that is configured to support one or more fire resistant glass panels for installation in a building or other structure. Aluminum provides the advantage of strength with a light-weight construction that is more easily handled and installed versus prior art steel designs. The improvements include a snap connector that does not have any sharp edges and that is made lightweight and easily assembled and that more securely connects the frame components together.

Also provided is window frame system comprising: a plurality of framing members, each framing member having a connector slot; a first connector member configured to be inserted into and held in place by the connector slot provided on a first one of said framing members; and a second connector member configured to be inserted into and held in place by the connector slot provided on a second one of said framing members. The first connector member is configured to connect with said second connector member to connect said first one of said framing members to said second one of said framing members configured in a manner to hold a portion of a glass panel between said first one of said framing members and said second one of said framing members.

Further provided is the above system further comprising: a third connector member configured to be inserted into and held in place by the connector slot provided on a third one of said framing members; a fourth connector member configured to be inserted into and held in place by the connector slot provided on a fourth one of said framing members, wherein said third connector member is configured to connect with said fourth connector member to connect said third one of said framing members to said fourth one of said framing members configured in a manner to hold another portion of said glass panel between said third one of said framing members and said fourth one of said framing members, and wherein said first one of said framing members and said second one of said framing members are configured when connected together to hold one end portion of the glass panel, and further wherein said third one of said framing members and said fourth one of said framing members are configured when connected together to hold another end portion of the glass panel.

And further provided is window frame system comprising: a plurality of framing members, each framing member comprising a plurality of sides forming a hollow interior, said framing members each having a connecting side configured with a connector slot; a filler material provided in said hollow interior of said plurality of framing members; a male connector member configured to be inserted and held in place by the connector slot provided on a first one of said framing members; a female connector member configured to be inserted and held in place by the connector slot provided on a second one of said framing members, wherein said male connector member is configured with a male part that removably inserts and snaps into a corresponding female part of said female connector member to securely connect said male connector member to said female connector member, such that said first one of framing members is configured with said second one of said framing members in a manner configured to hold a first end portion of a glass panel between said first framing member and said second framing member by action of said first framing member connecting with said second framing member.

Also provided are any of the above window systems further comprising: a third male connector member configured to be inserted and held in place by the connector slot provided on a fifth one of said framing members; a third female connector member configured to be inserted and held in place by the connector slot provided on a sixth one of said framing members, wherein said third male connector member in conjunction with said third female connector member are configured to hold said fifth one of said framing members to said sixth one of said framing members to hold a third end portion of a glass panel between said fifth framing member and said sixth framing member by action of said fifth framing member connecting with said sixth framing member; a fourth male connector member configured to be inserted and held in place by the connector slot provided on a seventh one of said framing members; and a fourth female connector member configured to be inserted and held in place by the connector slot provided on an eighth one of said framing members, wherein said fourth male connector member in conjunction with said fourth female connector member are configured to hold said seventh one of said framing members to said eighth one of said framing members to hold a fourth end portion of a glass panel between said seventh framing member and said eight framing member by action of said seventh framing member connecting with said eight framing member.

Further provided is a window frame system comprising: a plurality of framing members, each framing member comprising a plurality of sides forming a hollow interior, said framing members each having a connecting side configured with a connector slot; filler material provided in the hollow interior of each one of said plurality of framing members; a plurality of male connector members configured to be inserted and held in place by respective connector slots provided on each one of a first set of said framing members; a plurality of female connector members configured to be inserted and held in place by respective connector slots provided on a second set of said framing members, wherein each one of said framing members of said first set having at least one of said male connected members mounted thereon is paired and connected with a respective one of said framing members of said second set having a respective at least one female connector member mounted thereon and connected to said respective at least one male connected member, such that each connected pair of framing members is configured to hold a different respective edge of a glass panel therebetween.

Also provided is a method of installing any of the above systems in a building such that an interior window frame is installed, a window panel is put and held in place, and an exterior window frame connected to the interior window frame.

Further provided is a method for installing a window panel comprising the steps of:
providing at least four connecting members each having a first connecting part for removably connecting to a respective second connecting part;
providing at least four inner framing members, each one of said inner framing members having a connector slot provided therein;
installing at least one of said first connecting parts on each one of said four inner framing members using the connector slot of each inner framing member for receiving the respective first connecting part;
providing at least four outer framing members, each one of said outer framing members having a connector slot provided therein;
installing at least one of said second connecting parts on each one of said four outer framing members using the connector slot of each outer framing member for receiving the respective second connecting part;
installing said four inner framing members in an interior of said building by securing each one of said inner framing members to a structure of said building to form an inner window frame;
placing a window panel against the inner window frame and holding the window panel in place;
connecting each one of said outer framing members to a respective one of said inner framing members by connecting the second connecting member installed on each one of said outer framing members to the first connecting member installed on a respective one of said inner framing members to form an outer window frame connected to said inner window frame thereby securing said window panel between said inner window frame and said outer window frame.

Still further provided is a method for installing a window panel comprising the steps of:
providing at least four connecting members each having a first connecting part for removably connecting to a respective second connecting part;
providing at least four inner framing members, each one of said inner framing members having a connector slot provided therein;
installing at least one of said first connecting parts on each one of said four inner framing members using the connector slot of each inner framing member for receiving the respective first connecting part;
providing at least four outer framing members, each one of said outer framing members having a connector slot provided therein;
installing at least one of said second connecting parts on each one of said four outer framing members using the connector slot of each outer framing member for receiving the respective second connecting part;
installing said four inner framing members in an interior of said building by securing each one of said inner framing members to a structure of said building to form an inner window frame;
forming an outer window frame from said four outer framing members by connecting said four outer framing members together using dowels inserted in holes of adjacent ones of said outer framing members to form said outer window frame having four corners;
placing a window panel against the inner window frame and holding the window panel in place;
connecting said outer window frame to said inner framing members by connecting the second connecting member installed on each one of said outer framing members to the first connecting member installed on a respective one of said inner framing members to connect said outer window frame to said inner window frame already installed in said building thereby securing said window panel between said inner window frame and said outer window frame.

Further provided are any of the above systems or methods wherein the connectors are configured to connect at various depths allowing accommodation of window panels of various thicknesses. Also provided are embodiments where various components, including the framing members, are made of aluminum or aluminum alloys.

Also provided are additional example embodiments, some, but not all of which, are described hereinbelow in more detail.

### BRIEF DESCRIPTION OF THE DRAWINGS

The features and advantages of the example embodiments described herein will become apparent to those skilled in the art to which this disclosure relates upon reading the following description, with reference to the accompanying drawings, in which:

FIG. 1 is a schematic drawing showing one example embodiment of a window frame of the invention holding window panels in place;

FIG. 2 is a schematic drawing showing a three-dimensional exploded perspective view of the primary components of an example embodiment of the invention for holding a window panel;

FIG. 3 is a schematic drawing of a partially assembled view of the drawing in FIG. 1;

FIG. 4 is a schematic drawing of an exploded perspective partial view of an example window system according to the invention;

FIG. 4A shows an assembled version of the example of FIG. 4;

FIG. 5 is a schematic drawing of an example jamb detail structure according to the invention;

FIG. 6 is a schematic drawing of an example horizonal mullion detail structure according to the invention;

FIG. 7 is a schematic drawing of an example vertical mullion detail structure according to the invention;

FIG. 8 is a schematic drawing of an example head detail structure according to the invention;

FIG. 9 is a schematic drawing of an example sill detail structure according to the invention;

FIG. 10 is a schematic drawing of an example horizontal and vertical mullion interface detail structure according to the invention;

FIG. 11 is a schematic drawing of an example exploded view of external horizontal and vertical structures according to the invention;

FIG. 12A is a schematic drawing of an example male connector element that can be used in various embodiments of the invention;

FIG. 12B is a schematic drawing of an example female connector element that can be used in various embodiments of the invention;

FIG. 13 is a schematic drawing of an alternative example head structure of the invention;

FIG. 14 is a schematic drawing of the alternative example sill structure of the invention; and

FIG. 15 is a schematic drawing of a cut away view of a pair of frame members that have been “snapped” together to form a center frame part structure of the alternative example of the invention.

### DETAILED DESCRIPTION OF THE EXAMPLE EMBODIMENTS

U.S. Pat. No. 9,234,345, incorporated by reference, discloses a snap together frame that exhibits fire resistance. The disclosure herein provides substantial improvements over that system as discussed hereinbelow, and including, in certain embodiments, one or more of: eliminating the “sub-frame” which reduces the weight and complexity of installation; replacing steel with an all-aluminum frame system; substantially reducing weight; reducing bulk and reducing the use of heavy steel hollow metal framing; improving ease of installation; eliminating the use of some fasteners to secure the caps; and improving esthetics to provide a look similar to current storefront systems.

Various embodiments of framing systems disclosed herein are formed using framing members that are formed into a rectangular frame for holding a window in a building. The framing members are designed such that some framing members are installed in the building to form an inner window frame by attaching them to structures of the building using attaching hardware. Then, a window panel (comprised of various types of window structures that may have one or more window panes, insulating gaps, etc.) can be placed in the inner frame (using, where desired, cushioning hardware—such as gaskets, tape, etc.—installed on the framing members to hold the glass securely without damage) and an outer frame is “snapped” to the inner frame using a pair of “snap” connector parts that are installed on the framing members. The connector parts are designed to accommodate various thicknesses of window panels and yet still hold the selected window panel in place.

In some cases, the outer window frame may be pre-formed using a set of framing members connected together in advance (such as by using dowels inserted into slots provided on the framing members) so that the entire outer window frame can be installed onto the inner window frame on one step by snapping the connectors together. Alternatively, only subsets of the framing members (e.g., 2 at a time) might be connected together to form “corners” that are individually installed separately.

Because the “snap” connectors allow the other framing members to be removed in a reverse of the installation steps under the above scenario, the outer window frame may be more secured to the inner window frame using securing hardware such as screws and brackets, to make the installation more permanent. Alternatively, snaps that self-secure after installation might be used, or a means of making the snap connection more secure (e.g., using glue, welding, etc.) might be utilized.

These novel components and their novel assembly techniques allow windows to be more easily installed into buildings with less labor and fewer steps. It avoids the need for drilling and complicated securing steps for installing the outer window frame, avoiding excessive labor and easing the installation process. Furthermore, much of the structure can be made of aluminum or aluminum allows or other light but strong alloys, avoiding the use of steelworkers installing the windows in the building.

As discussed, the framing members can be connected together using connecting hardware, such as dowels (steel roll pin/rod structures) inserted into pin slots and/or drilled holes in the framing members, which are used to help structurally secure various frame members together and ease the installation process. The framing members are typically constructed with hollow interiors that are filled a filler material such as drywall (sheetrock) which improves the fire rating of the assembly. Although the framing members shown as examples in this application tend to have square cross sections, such members could be provided with rectangular cross sections or cross sections including curved or other types of angular surfaces, such as for aesthetic purposes or functional reasons.

These “snap” window frame units can be paired with an improved clarity fire rated glass such as that disclosed in U.S. Pat. No. 11,479,504 that was issued on Oct. 25, 2022 and is incorporated herein by reference. Using the frame with this glass provides a superior solution for fire-rated glass systems that can pass testing under National Fire Protection Association fire exposure tests, among others, specifically including: NFPA 257—Standard on Fire Test for Window and Glass Block Assemblies; NFPA 252: Standard Methods of Fire Tests of Door Assemblies; UL 9—Standard for Fire Tests of Window Assemblies; CAN/ULC-S106—Standard Method for Fire Testing of Window and Glass Block Assemblies; UL 263—Fire Tests of Building Construction and Materials; ASTM E119—Standard Test Methods for Fire Tests of Building Construction and Materials; NFPA 251—Standard Methods of Tests of Fire Resistance of Building Construction Materials; and CAN/ULC-S101—Standard Methods of Fire Endurance Tests of Building Construction Materials.

At least some of the disclosed embodiments have been fire tested with satisfactory results. For example, a 60 minute fire test showed positive results of an example frame assembly using aluminum formed framing structures tested with installed ceramic fire resistant glass. This assembly passed a hose-stream test. The preferred assemblies are designed to pass various commercial standards, including fire rating standards such as UL 9, NFPA 257, UL 263, ASTM E119, and NFPA 80, among others. Security standards (detention/ballistic) such as ASTM F1915, ASTM F1450, and UL 752 are also achieved.

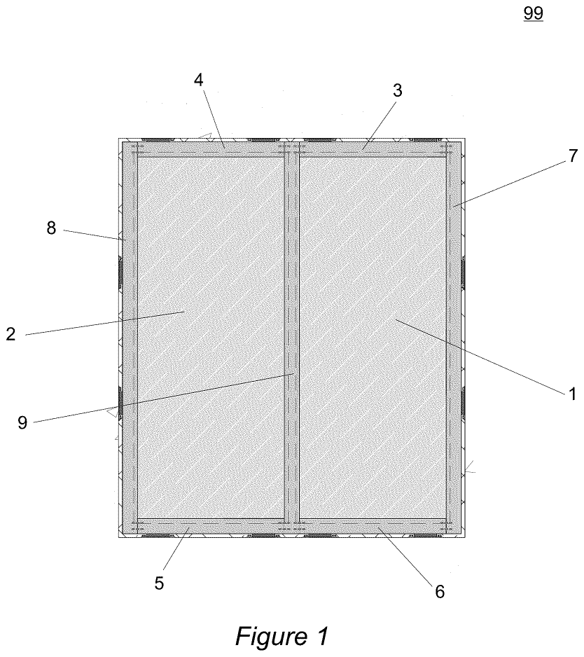

FIG. 1 shows a window panel installed in a window frame using the disclosed approach. Specifically, FIG. 1 shows an outside portion of a window 99 installed according to at least one embodiment of the invention. A pair of window panels 1, 2 are installed in a window frame comprising a plurality of connector members with external connector members 3, 4, 5, 6, 7, 8, and 9 providing an outer frame for the window with connector member 9 separating the window panels 1, 2 as part of the outer frame, with member 9 being connected at one end at a junction at ends of connector members 3 and 4 and at the other end at a junction at ends of connector members 5 and 6. Note that this outer frame is “snap” connected to an inner frame (not shown) structurally installed in a building (not shown).

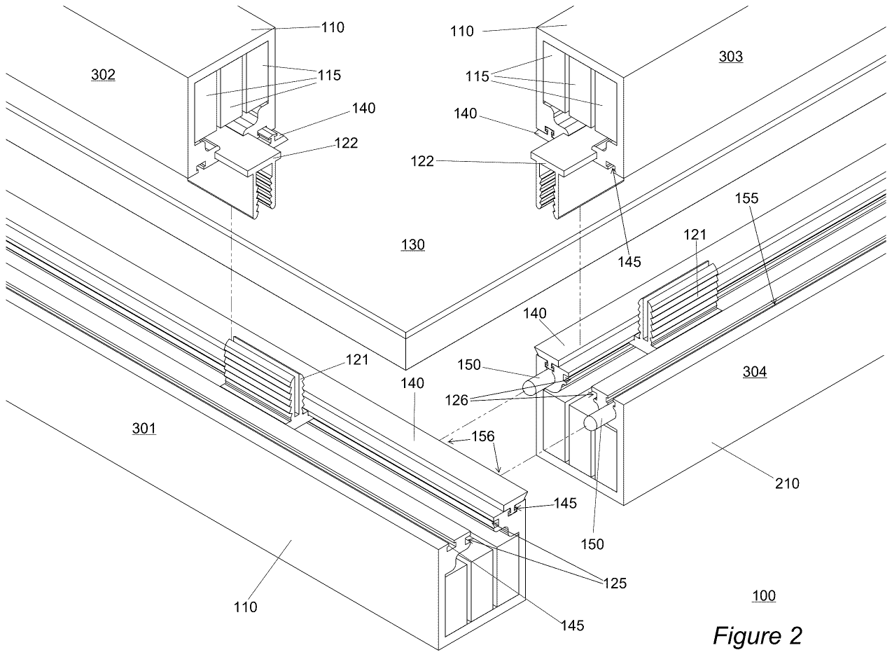

FIG. 2 shows a 3D perspective view of a preferable example embodiment 100 of a snap connector frame exhibiting fire resistance when used with fire resistant glass panels. The frame is comprised of a plurality of frame structures 301, 302, 303, and 304 described in more detail below, configured to hold a glass panel 130 in a window opening in a building.

The example frame structures 301, 302, and 303 are each comprised of a frame member 110 having two or more gasket slots 145 configured to receive a gasket 140. The frame members 110 also have a connector slot 125 configured to receive a male connector 121 or a female connector 122 (or both). The frame members 110 have a hollow interior that can receive filler material 115, such as drywall, concrete, plaster, fire resistant plastic or foam, or some other material that provides a secure structural function while substantially withstanding heat to aid in making the resulting frame structures fire resistant.

The example frame structure 304 is comprised of a frame member 210 having four or two or more pin slots 155 configured to receive a securing pin (dowel) 150 with the pin slots 155 also being configured to receive a gasket 140. Note that these can alternatively be provided as separate slots for the pin and the gasket. The frame members 210 also have a connector slot 126 configured to receive a male connector 121 or a female connector 122 (or both). The frame members 210 have a hollow interior that can receive the same filler material (or different filler material) as described for the framing members 110.

The frame members 110, 210 can be constructed of a hard, fire resistant material, such as aluminum or an aluminum alloy. Steel or fire resistant composites are alternative materials, as are other metal alloys or other materials.

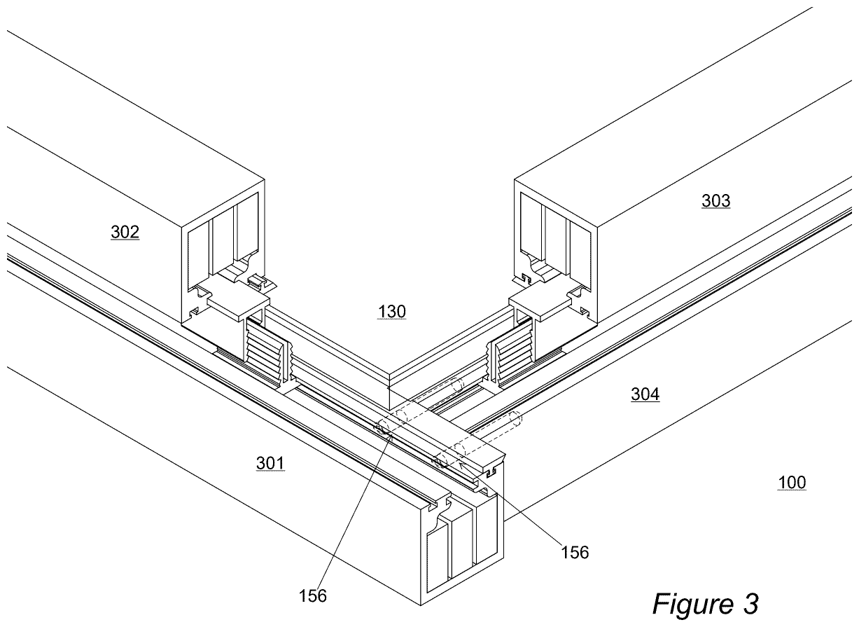

The frame structures 301, 302, 303, and 304 are configured and assembled together as shown in FIG. 3 to hold one or more glass panels 130 using the rubber (or other soft material) gasket 140 or provided between edges of the glass panel 130 and the frame structures to hold the glass panel in place.

The frame structures are assembled into place to hold the glass panel 130 by using the snap connectors 121, 122 by inserting (“snapping”) the male member 121 into the female member 122 (or vice versa) to hold the frame members together to form the frame structures and to secure the glass panel 130 in the assembled frame. The connector male and female members 121, 122, described in more detail hereinbelow, have structure that securely hold the frame members together for various thicknesses of glass panels, and that are hence adjustable based on the thickness of the glass panels, in that the male member 121 can be inserted into the female member 122 at various depths based on the thickness of the glass panel 130, and still securely hold the members together and thereby hold the glass panels in place.

The gasket or tape 140 can be comprised of a resilient or other padding material or tape that is preferably fire and heat resistant, such as a ceramic or rubber or composite material that is configured to securely hold the glass panel 130 in place between opposing frame structures. The snap connector male members 121 and female members 122 are installed into their respective frame members by sliding the respective connector members into and along the corresponding connector slot 125, 135 provided in the respective frame members 110, 210 to a desired location.

Note that frame structure 304 is connected to frame structure 301 using two pins (dowels) 150 that have one end that is inserted into the pin slots 155 of frame member 210, with the pins 150 having opposite ends inserted into drilled holes 156 in frame member 110 of frame structure 301. This secures frame structure 301 to frame structure 304 to make assembly of the entire window frame easier. Typically, this approach is used for the outside frame of the window, but this could also be used for an inside frame by replacing one of the structures 302, 303 with a structure like that of structure 304.

The pins 150 can be provided already fully installed in the slots 155 but be moved in place by sliding them outward (such as by using a screw driver through the slot 155) to expose them to mate with the corresponding drilled holes, if desired.

The frame members 110, 210 can be provided in any desired length, variable lengths, or equal lengths, as desired, and use of the common reference numbers does not imply that all such members are of the same length. Similarly, the glass panels 140 can be provided in different dimensions including different thicknesses and different compositions and structure, and use of the common reference numbers does not imply that all such members are of the same dimensions or even the same composition.

Note further that although FIG. 3 shows a gap in the corner of frame structures 302, 303, those structures could be arranged to meet and/or overlap to eliminate that gap, in particular by sliding the connector parts further down the connector slots.

Note still further that the male and female connector members 121, 122 are shown installed in an opposite manner in the example figures below, emphasizing that the placement of the connectors can be swapped as desired according to the needs of a particular application, or otherwise may be arbitrarily chosen.

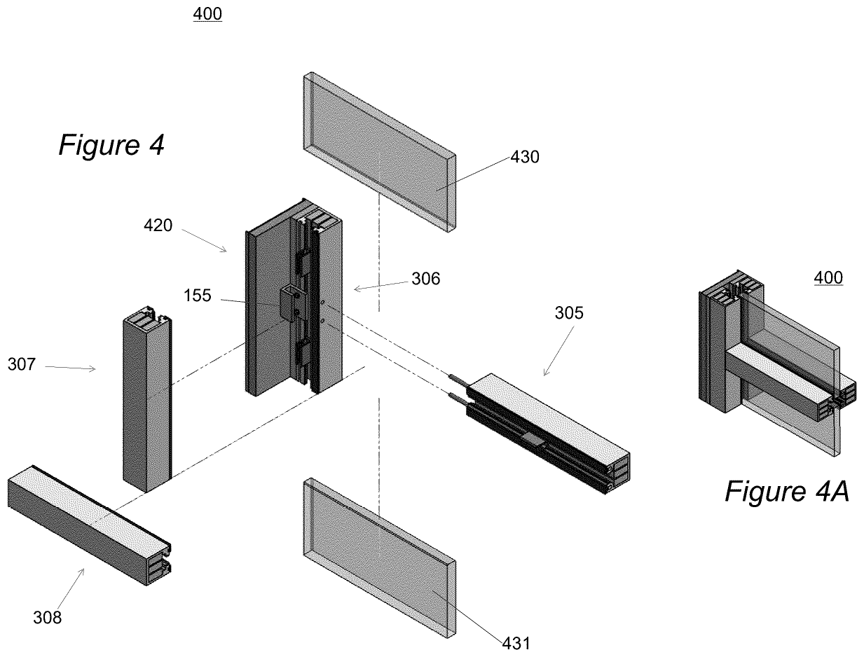

FIG. 4 shows an exploded perspective partial view of a window system 400 comprised of frame structures 305, 306, 307, and 308 forming a frame for holding glass panels 430, 431 with frame structure 306 being secured to building structure 420 using a mounting bracket 155. FIG. 4A shows these components in the window system 400 in an assembled manner.

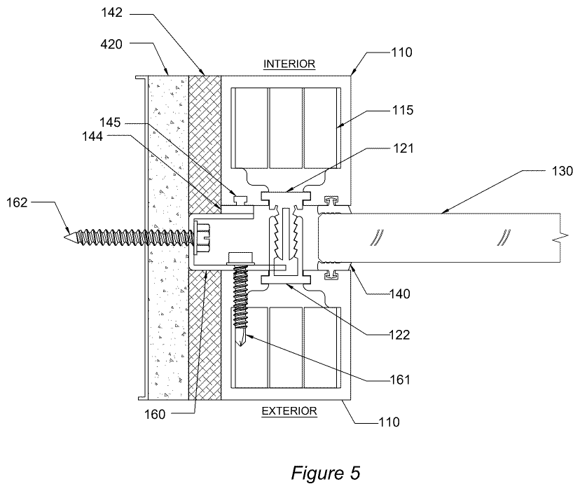

FIG. 5 shows a view of an example jamb detail showing a pair of frame members 110 each with a gasket 140 for contacting and holding glass panel 130, with one frame member (at the interior) having a male connector 121 provided in its connector slot and the other frame member (at the exterior) having a female connector 122 provided in its connector slot. EPDM tape 144 is provided on the (interior) frame member 110 over slot 145 at an installation bracket 160 configured with screw 162 to install the assembly on a building structure 420. Screw 161 is used to secure the bracket 160 to the (exterior) frame member 110. Filler material 115 is provided in the hollow interior of the frame members 110. Insulation 142 is provided between the frame members 110 and the building structure 420.

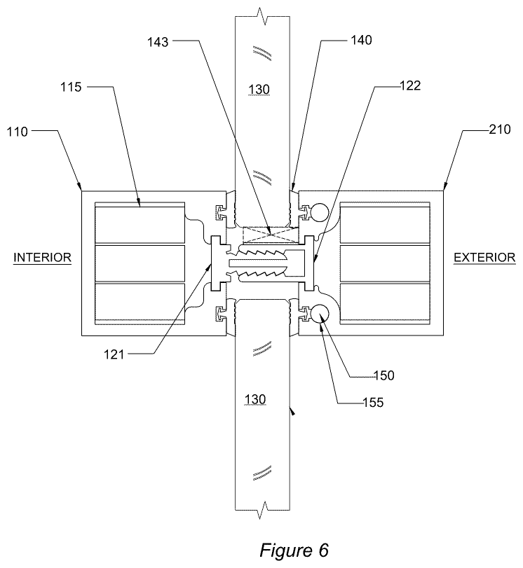

FIG. 6 shows a view of an example horizonal mullion detail showing a(n) (interior) frame member 110 with a pair of gaskets 140 and a male connector 121 provided in a connector slot, connected with a(n) (exterior) frame member 210 also with a pair of gaskets 140 and a female connector 122, a pair of pin slots 155 and with respective pins 150 inserted therein. A pair of glass panels 130 are held in place using the connected frame members and gaskets, with a setting block 143 against the upper glass panel. Filler material 115 is provided in the hollow interior of the frame members 110.

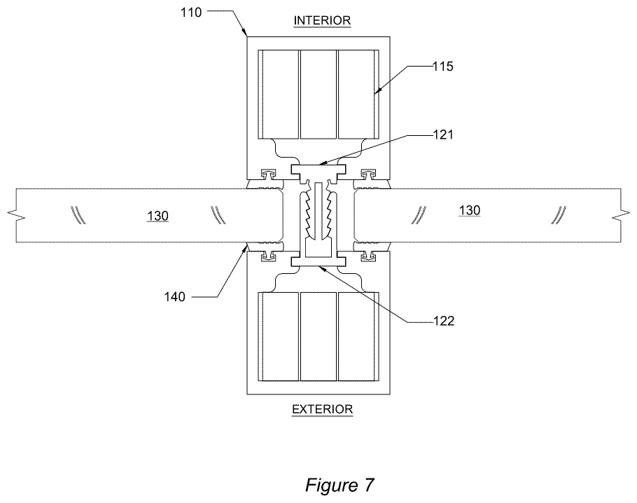

FIG. 7 shows a view of an example vertical mullion detail showing a(n) (interior) frame member 110 with a pair of gaskets 140 and a male connector 121 provided in its connector slot, connected with a(n) (exterior) frame member 110 also with a pair of gaskets 140 and a female connector 122 inserted in its connector slot. A pair of glass panels 130 are held in place using the connected frame members and gaskets. Filler material 115 is provided in the hollow interior of the frame members 110.

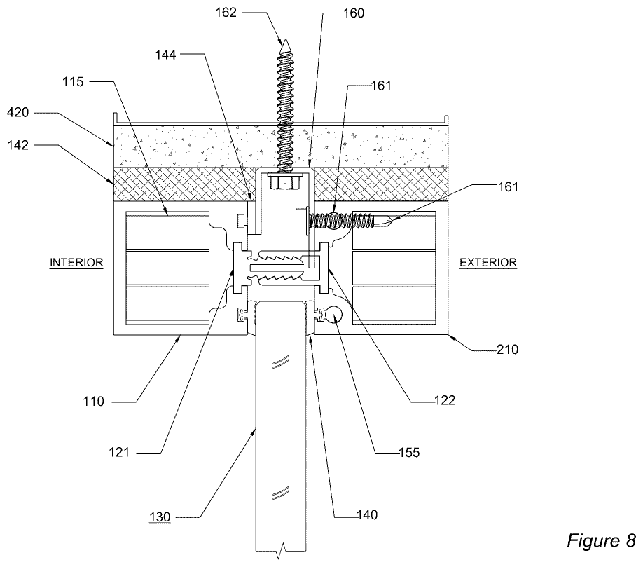

FIG. 8 shows a view of an example head detail showing a(n) (interior) frame member 110 with a gasket 140 and a male connector 121 provided in a connector slot, connected with a(n) (exterior) frame member 210 also with a gasket 140 and a female connector 122, a pair of pin slots 155. EPDM tape 144 is provided on the (interior) frame member 110 at an installation bracket 160 configured with screw 162 to install the assembly on a building structure 420. Screw 161 is used to secure the bracket 160 to the (exterior) frame member 210. A glass panel 130 is held in place using the connected frame members and gaskets. Filler material 115 is provided in the hollow interior of the frame members 110. Insulation 142 is provided between the frame members 110, 210 and the building structure 420. This assembly is used at the head (top) of the window frame.

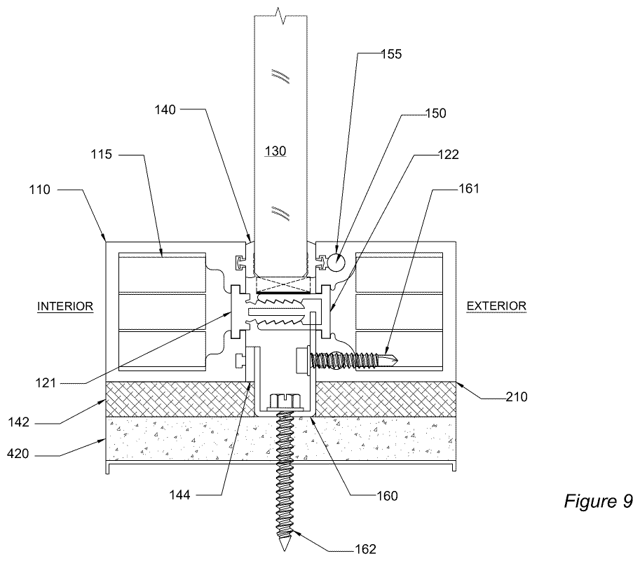

FIG. 9 shows a view of an example sill detail showing a(n) (interior) frame member 110 with a gasket 140 and a male connector 121 provided in a connector slot, connected with a(n) (exterior) frame member 210 also with a gasket 140 and a female connector 122, a pair of pin slots 155. EPDM tape 144 is provided on the (interior) frame member 110 at an installation bracket 160 configured with screw 162 to install the assembly on a building structure 420. Screw 161 is used to secure the bracket 160 to the (exterior) frame member 210. A glass panel 130 is held in place using the connected frame members and gaskets. Filler material 115 is provided in the hollow interior of the frame members 110. Insulation 142 is provided between the frame members 110, 210 and the building structure 420. This assembly is used at the sill (bottom) of the window frame.

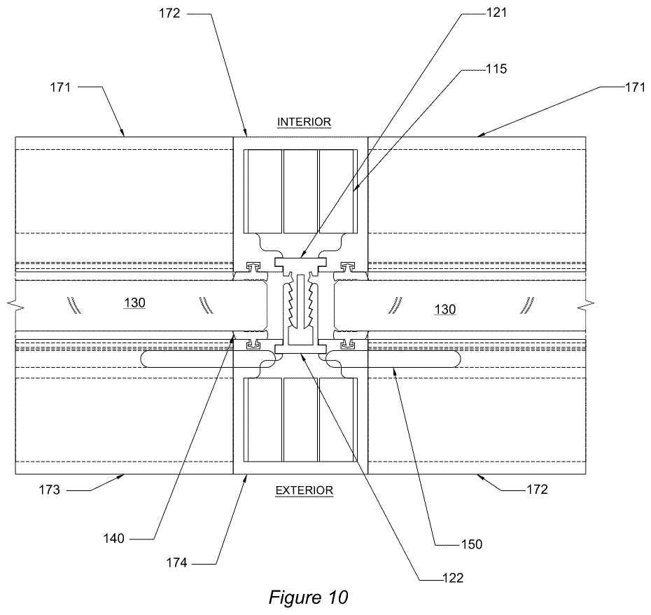

FIG. 10 shows an example of a horizontal and vertical mullion interface detail, having interior horizontal mullion frame structures 171 connected to an internal vertical mullion frame structure 172, along with exterior horizontal mullion frame structures 173 connected to an external vertical mullion frame structure 174, all assembled to hold a pair of glass panels 130 using a plurality of gaskets 140. The horizontal structures are connected using male and female connectors as shown elsewhere hereinabove, while the vertical structures are connected by at least the shown male connector 121 and the female connector 122. The external horizontal frame structures 173 are connected to the external vertical frame structure 174 using pins 150 as also described hereinabove.

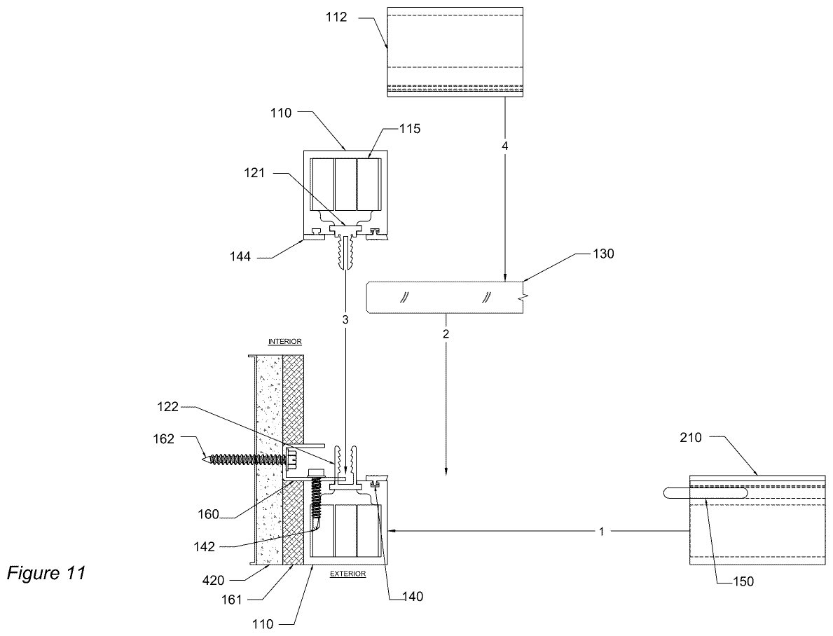

FIG. 11 shows an exploded view of the structures external horizontal and vertical structures described above with the numbered arrows showing the preferred assembly order.

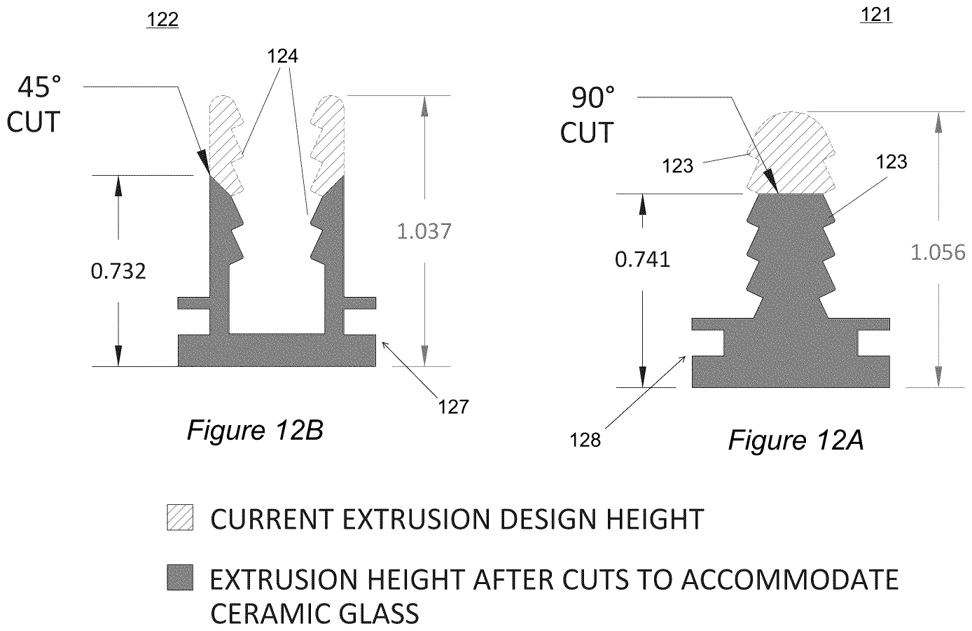

FIG. 12A shows an example male connector element having ridges 123 and a base 128. This connector can be cut by 90° at the cut mark to cut off the hashed portion for use with ceramic glass panels, for example, with the full connector being used for the thicker clear glass panels.

FIG. 12B shows an example female connector element having ridges 124 and a base 129. This connector can be cut by 45° at the cut mark to cut off the hashed portion for use with ceramic glass panels, for example, with the full connector being used for the thicker clear glass panels. The ridges 124 match the ridges 123 of the male connector 121 to securely connect the two parts together in a removable manner. The use of the multiple ridges allow the connectors to securely connect at various insertion depths to accommodate glass panels of various thicknesses.

The male and female connector parts 121, 122 can be comprised of aluminum, an aluminum alloy, a composite material, or some other lightweight material that provides a secure structural function while substantially withstanding heat.

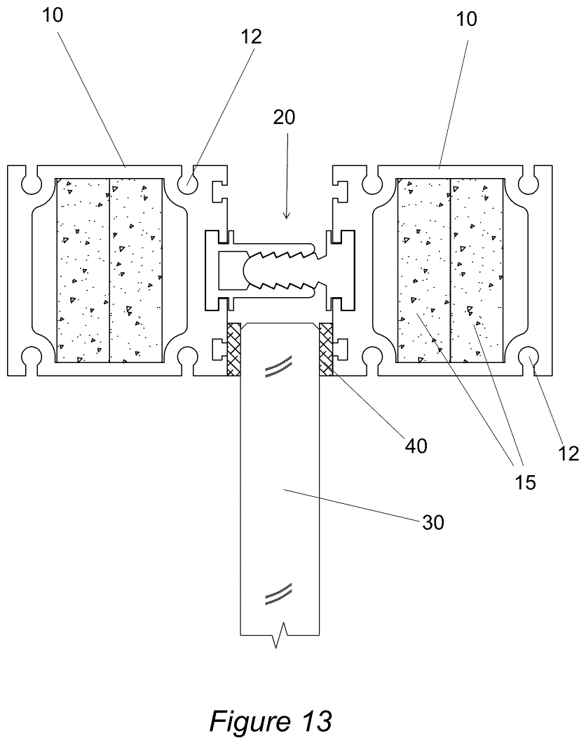

An alternative embodiment is shown in FIGS. 13-15 and described hereinbelow:

FIG. 13 shows a schematic diagram of a cut away view of a pair of frame members 10 that have been “snapped” together to hold a glass panel 30 along a top edge of the glass panel 30 using gaskets 40. Connector 20 has a male and a female part that connect securely but removably together. The frame members 10 have slots 12 that can receive pins to help hold the members together by connecting a pin inserted into the slot 12 to have a portion also inserted into a matching hole drilled in an adjacent member. The frame members 10 are made hollow for filling the void with a filler material such as plaster or drywall (sheetrock).

This provides a “head” structure that caps a top edge of the glass panel and provides structural support to the glass panel by connecting the snapped together frame to a window frame or other building structure.

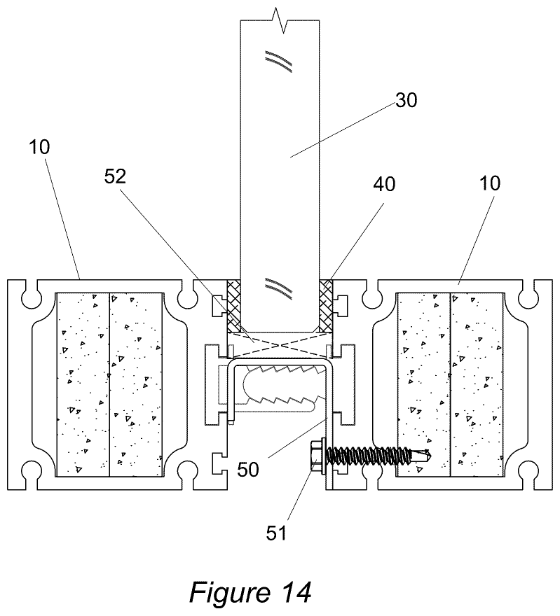

FIG. 14 shows a schematic diagram of a cut away view of a pair of frame members 10 that have been “snapped” together to hold a glass panel 30 along a bottom edge of the glass panel 30 using gaskets 40. In order to support the glass panel 30, a support bracket 50 is provided that is secured to one of the frame members 10 using a screw 51 or other fastening component. A support block 52, such as a calcium silicate setting block, is provided between the support bracket 50 and the bottom edge of the glass panel 30 to securely hold the glass panel 30 in place without damage. This assembly provides a “sill” structure that holds a bottom edge of the glass panel and can provide structural support to the glass panel by connecting the snapped together frame to a window frame or other building structure.

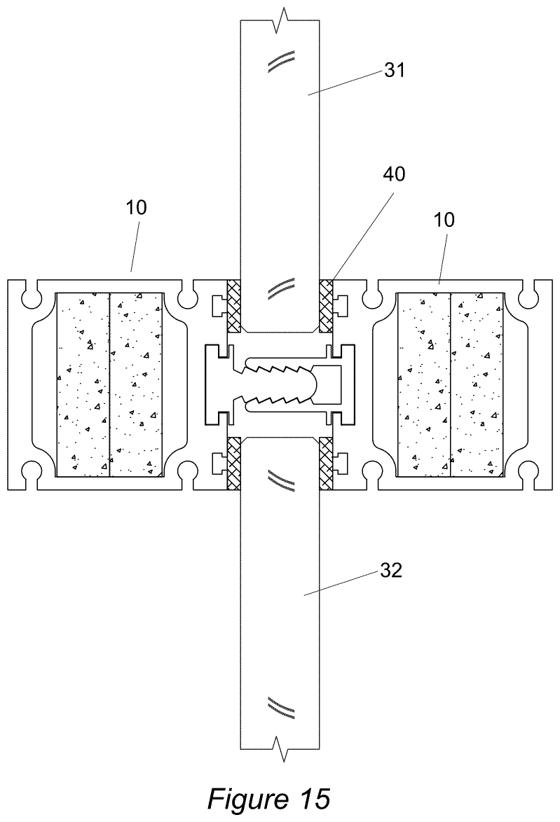

FIG. 15 shows a schematic diagram of a cut away view of a pair of frame members 10 that have been “snapped” together to form a center frame part for holding a pair of glass panels 30 along a bottom edge of one glass panel 31 and a top edge of an adjacent glass panel 32, effectively stacking the glass panels 31, 32 on top of each other along an edge. A support block (not shown) can be provided between a support bracket (not shown) and the bottom edge of the glass panel 30 to securely hold the glass panel 30 in place without damage. In this way, multiple glass panels can be stacked together to form a larger vertical structure or a more decorative structure.

Note that the frame members of this embodiment can be connected to the structure of the building in a manner similar to that shown for the other embodiment as shown using the bracket and screw discussed hereinabove.

The various framing designs of the invention can be utilized with window panels of various types and constructions. Fire rated panels can be utilized, including ceramic glass panels and clear glass panels, wired glass panels, and other types of panels. The system can accommodate insulated glass panels made of one or more panes of glass, laminated glass, bullet resistant glass, simple annealed glass, safety glass, tempered glass, and glass substitutes like acrylic and polycarbonate panels (e.g., plexiglass), and other types of panels. Even panels that are not transparent but provide other benefits, such as insulation, fire resistance, ballistic resistance, etc. can also be utilized. These frames are configured to be adjustable in depth to accommodate panels of various thicknesses and types, as desired, and can be further adapted by choosing desired connector sizes and types of the desired configuration.

Generally, any of the above embodiments can be installed in a building by assembling/installing an inner window frame using four or more framing members with at least some of these framing members being physically attached to structures of the building. Then, a glass panel (or multiple panels) is put in place against the interior frame, and held in place (such as by using a temporarily placed holding clip or other hardware), and an external window frame is “snapped” into place by inserting the connecting members together. The external window frame may be pre-assembled in advance using the assembly hardware (e.g., slots, drilled holes, and pins/dowels) described herein to ease the assembly process. Because the connecting members are designed for variable spacing of the framing members (internal from external), the system can accommodate window panels of various thicknesses and types. If desired, the external window frame can be more securely fastened to the interior window frame using fastening hardware such as brackets and/or screws or bolts.

A more detailed example installation process is as follows:
Pre-install loosely the “installation brackets” on perimeter of the horizontal and vertical exterior framing members with fasteners.
Measuring the wall's rough opening for the frame, locate approximately the center of the opening in depth and attach the vertical exterior framing members to the wall's rough opening with the installation brackets attached with appropriate wall anchors.
Adjust both vertical exterior framing members until they are both aligned horizontally and level (in a 90 degree angle to the floor) and pin holes are aligned horizontally, equal and opposite to the other verticals in the assembly, within the rough opening.
Install the horizontal exterior framing members at each location where there are holes drilled in the vertical exterior framing members by inserting the “dowels” with a screwdriver or similar tool. Check for alignment horizontally (align and level). See FIG. 3 for example.
Once horizontal exterior members are secured with dowels, adjust the frame assembly as needed (plumb and square) in the wall's rough opening and tighten all fasteners and anchors on each “installation bracket” around the perimeter of the exterior framing members.
At each setting block locations marked, place the appropriate setting blocks on to the two (2) brackets at the bottom of each glazed opening. See FIG. 6; item 143 for example.
At the center of each horizontal exterior framing member, install the temporary glass securing clips.
NOTE: Ensure the orientation of the glass clips will not interfere with the setting of the glass units.
With help, place each glass unit on to the setting blocks (as mentioned in the step of paragraph 0096) placed in each opening.
Temporarily secure each glass unit along the horizontal edge at the center using the temporary glass securing clips installed.
Next, install the vertical interior framing members to the vertical exterior framing members by aligning the male and female clips and “snapping” the connectors together by hand or with a rubber mallet (if needed).
NOTE: check to make sure the framing members snapped on are snug and tight against the glass unit.
Once all vertical interior framing members are installed, remove the temporary glass securing clips from the horizontal exterior framing members.
Install the horizontal interior framing members by aligning the male and female clips and “snapping” the connectors together by hand or with a rubber mallet (if needed).
Check to make sure all framing members are secure and tight around the perimeter of the frame assembly.
Install in the void between the frame assembly and the wall's rough opening, around the perimeter, insulation as needed.
Seal the perimeter with caulk or silicone to cover and seal the insulation within the void on the exterior and interior side of the frame assembly as needed.

Note that some of these steps may be performed in advance at a remote location such as a factory or other assembly location. For example, the exterior (or even interior) frame could be assembled in advance at a remote location, and various components installed in advance, such as mounting brackets and connectors.

Many other example embodiments can be provided through various combinations of the above described features. Although the embodiments described hereinabove use specific examples and alternatives, it will be understood by those skilled in the art that various additional alternatives may be used and equivalents may be substituted for elements and/or steps described herein, without necessarily deviating from the intended scope of the application. Modifications may be necessary to adapt the embodiments to a particular situation or to particular needs without departing from the intended scope of the application. It is intended that the application not be limited to the particular example implementations and example embodiments described herein, but that the claims be given their broadest reasonable interpretation to cover all novel and non-obvious embodiments, literal or equivalent, disclosed or not, covered thereby.

1. A window frame system comprising:
a plurality of framing members, each framing member having a connector slot;
a first connector member configured to be inserted into and held in place by the connector slot provided on a first one of said framing members; and
a second connector member configured to be inserted into and held in place by the connector slot provided on a second one of said framing members, wherein
said first connector member is configured to connect with said second connector member to connect said first one of said framing members to said second one of said framing members configured in a manner to hold a portion of a glass panel between said first one of said framing members and said second one of said framing members.

2. The system of claim 1, wherein said plurality of framing members are comprised of aluminum or an aluminum alloy.

3. The system of claim 1, wherein said plurality of framing members have a hollow interior substantially filled with a filler material.

4. The system of claim 1, wherein said plurality of framing members have a substantially rectangular cross section and where each one of said framing members has an framing slot provided at an end of said framing members at a corner of said end.

5. The system of claim 4, wherein said framing slot is configured to receive a dowel configured to connect the end of said first one of said framing members to a side of another one of said framing members to form a corner of said framing system.

6. The system of claim 5, wherein said framing slots are also configured to receive one or more cushion devices configured to contact and hold said glass panel in a cushioned manner.

7. The system of claim 4, wherein said framing slots are configured to receive one or more cushion devices configured to contact and hold said glass panel in a cushioned manner.

8. The system of claim 4, wherein said framing slots are configured to run along a substantial length of said framing members.

9. The system of claim 4, wherein some of said framing slots are configured to receive one or more cushion devices configured to contact and hold said glass panel in a cushioned manner, whereas others of said framing slots are configured to receive one or more dowels configured to connect the end of one of said framing members to a side of another of said framing members to form a corner of said framing system.

10. The system of claim 1, wherein said first connector member is configured as a male part for insertion into a corresponding female part of said second connector member.

11. The system of claim 10, wherein said male connector member has a series of ridges provide on an outer surface thereof corresponding to a series of ridges provided on an inner surface of said female connector member, such that said male connector member is configured to connect with said female connector member by said insertion in a secure and removable manner.

12. The system of claim 11, wherein said male connector member is configured to connect with said female connector member in a secure and removable manner at different insertion depths allowing variable spacing between said first framing member and said second framing member to adapt to different thicknesses of said window pane.

13. The system of claim 1, further comprising mounting hardware configured to mount said first framing member to a structure of a building to hold said window pane with said window frame system.

14. The system of claim 13, wherein said window pane is mounted to said building with said window frame system to hold said window pane in place without mounting said second framing member to said structure of said building.

15. The system of claim 14, further comprising frame connecting hardware configured to securely connect said second framing member to said first framing member to prevent said first framing member from being disconnected from said second framing member after installation of said window pane in said building.

16. The system of claim 1, further comprising:
a third connector member configured to be inserted into and held in place by the connector slot provided on a third one of said framing members; and
a fourth connector member configured to be inserted into and held in place by the connector slot provided on a fourth one of said framing members, wherein
said third connector member is configured to connect with said fourth connector member to connect said third one of said framing members to said fourth one of said framing members configured in a manner to hold another portion of said glass panel between said third one of said framing members and said fourth one of said framing members, and wherein
said first one of said framing members and said second one of said framing members are configured when connected together to hold one end portion of the glass panel, and wherein
said third one of said framing members and said fourth one of said framing members are configured when connected together to hold another end portion of the glass panel.

17. The system of claim 16, wherein said first one of said framing members and said second one of said framing members are arranged connected together to form a corner with said third one of said framing members connected to said fourth one of said framing members.

18. The system of claim 17, wherein said first one of said framing members is provided with a framing slot for receiving a dowel that is connected to said third one of said framing members via a hole drilled into said third one of said framing members to form said corner.

19. The system of claim 1, wherein said first connector member is provided near one end of said first framing member and wherein said second connector member is provided near one end of said second framing member.

20. The system of claim 19, wherein a fourth connector member is provided near another end of said first framing member and wherein a fifth connector member is provided near another end of said second framing member such that said fourth connector member connects with said fifth connector member to further connect said first framing member to said second framing member.

21. The system of claim 1, wherein said glass panel is comprised of a plurality of panes of glass.

22. A window frame system comprising:
a plurality of framing members, each framing member comprising a plurality of sides forming a hollow interior, said framing members each having a connecting side configured with a connector slot;
a filler material provided in said hollow interior of said plurality of framing members;
a male connector member configured to be inserted and held in place by the connector slot provided on a first one of said framing members;
a female connector member configured to be inserted and held in place by the connector slot provided on a second one of said framing members, wherein
said male connector member is configured with a male part that removably inserts and snaps into a corresponding female part of said female connector member to securely connect said male connector member to said female connector member, such that
said first one of framing members is configured with said second one of said framing members in a manner configured to hold a first end portion of a glass panel between said first framing member and said second framing member by action of said first framing member connecting with said second framing member.

23. The window frame system of claim 22, wherein said male connector member is configured to be inserted into said female connector member at variable depths in a secure manner to accommodate glass panels of different thicknesses.

24. The window frame system of claim 22, further comprising:
a second male connector member configured to be inserted and held in place by the connector slot provided on a third one of said framing members; and
a second female connector member configured to be inserted and held in place by the connector slot provided on a fourth one of said framing members, wherein
said second male connector member in conjunction with said second female connector member are configured to hold said third one of said framing members to said fourth one of said framing members to hold a second end portion of a glass panel between said third framing member and said fourth framing member by action of said third framing member connecting with said fourth framing member.

25. The window frame system of claim 24, wherein said first framing member is connected to said third framing member using a connecting dowel to form a corner.

26. The window frame system of claim 25, further comprising:
a third male connector member configured to be inserted and held in place by the connector slot provided on a fifth one of said framing members;
a third female connector member configured to be inserted and held in place by the connector slot provided on a sixth one of said framing members, wherein
said third male connector member in conjunction with said third female connector member are configured to hold said fifth one of said framing members to said sixth one of said framing members to hold a third end portion of a glass panel between said fifth framing member and said sixth framing member by action of said fifth framing member connecting with said sixth framing member;
a fourth male connector member configured to be inserted and held in place by the connector slot provided on a seventh one of said framing members; and
a fourth female connector member configured to be inserted and held in place by the connector slot provided on an eighth one of said framing members, wherein
said fourth male connector member in conjunction with said fourth female connector member are configured to hold said seventh one of said framing members to said eighth one of said framing members to hold a fourth end portion of a glass panel between said seventh framing member and said eight framing member by action of said seventh framing member connecting with said eight framing member.

27. The window frame system of claim 26, further comprising additional male connector members connecting to additional female connecting members for further connecting various ones of said framing members to respective others of said framing members.

28. The window frame system of claim 26, wherein said fifth framing member is connected to said sixth framing member using another connecting dowel to form another corner.

29. A window frame system comprising:
a plurality of framing members, each framing member comprising a plurality of sides forming a hollow interior, said framing members each having a connecting side configured with a connector slot;
filler material provided in the hollow interior of each one of said plurality of framing members;
a plurality of male connector members configured to be inserted and held in place by respective connector slots provided on each one of a first set of said framing members;
a plurality of female connector members configured to be inserted and held in place by respective connector slots provided on a second set of said framing members, wherein
each one of said framing members of said first set having at least one of said male connected members mounted thereon is paired and connected with a respective one of said framing members of said second set having a respective at least one female connector member mounted thereon and connected to said respective at least one male connected member, such that each connected pair of framing members is configured to hold a different respective edge of a glass panel therebetween.

30. The window frame system of claim 29, wherein each connected pair of framing members is connected using two male connector members connected respectively to two female connector members.

31. The window frame system of claim 29, wherein at least one connected pair of said framing members is attached to another connected pair of said framing members using a dowel inserted into respective slots in each connected pair of framing members, such that said attached connected pairs of said framing members form a corner.

32-37. (canceled)
